(19) United States
(12) Patent Application Publication
(10) Pub. No.: US 2012/0331387 A1
(43) Pub. Date: Dec. 27, 2012

(54) METHOD AND SYSTEM FOR PROVIDING GATHERING EXPERIENCE

(75) Inventors: Tara Lemmey, San Francisco, CA (US); Nikolay Surin, San Francisco, CA (US); Stanislav Vonog, San Francisco, CA (US)

(73) Assignee: Net Power and Light, Inc., San Francisco, CA (US)

(21) Appl. No.: 13/528,123

(22) Filed: Jun. 20, 2012

Related U.S. Application Data
(60) Provisional application No. 61/499,567, filed on Jun. 21, 2011.

(51) Int. Cl. G06F 3/048; G06F 3/01; G06F 3/16

(52) U.S. Cl. 715/727; 715/781; 715/751

(57) ABSTRACT

The present disclosure relates to the use of gestures and feedback to facilitate gathering experiences and/or applause events with natural, social ambience. For example, audio feedback responsive to participant action may swell and diminish in response to intensity and social aspects of participant participation. Each participant can have unique sounds or other feedback assigned to represent their actions to create a social ambience.

### CROSS-REFERENCE TO RELATED APPLICATIONS

This application claims the benefit of priority under 35 U.S.C. 119(e) to U.S. Provisional Patent Application No. 61/499,567, which was filed on Jun. 21, 2011, entitled METHOD AND SYSTEM FOR APPLAUSE EVENTS WITH SWELL, DIMINISH, AND SOCIAL ASPECTS,” the contents of which are expressly incorporated herein by reference.

### FIELD OF INVENTION

The present disclosure relates to the use of gestures and feedback to facilitate gathering experience and/or applause events with natural, social ambience. For example, audio feedback responsive to participant action may swell and diminish in response to intensity and social aspects of participant participation and each participant can have unique sounds or other feedback assigned to represent their actions to create a social ambience.

### BACKGROUND

Many people enjoy attending live events at physical venues or watching games at stadiums because of the real experience and fun in engaging with other participants or fans, as illustrated in FIG. 1. At physical venues of live events or games, participants or fans may cheer or applaud together and feel the crowd's energy. Applause is normally defined as a public expression of approval, such as clapping. Applause generally has social aspects that manifest in a variety of ways. Additionally, the intensity of the applause is a function of the intensity of participation, especially with regard to the specific gestures made, the number of participants, and the character of the participation.

However, factors, such as cost, convenience etc., may limit the frequency that ordinary people could attend live events or watch live games at stadiums.

Alternatively, people may choose to communicate with each other through Internet or watch broadcasted games on TVs or computers, which is illustrated in FIG. 2A. However, existing technologies do not provide options for people to effectively engage with other participants of the live events or games.

There is not really much that has been done to date regarding human to human gestural communications assisted by technology, as illustrated by FIG. 2B. One example is Skype® virtual presence (where one is communicating with other people and one sees his or her video image and his or her gesturing but that's just the transmission of an image). Other examples include MMS, multi-media text message where participants send a picture or a video of experiences using, for example, YouTube®, to convey emotions or thoughts—these really do not involve gestures, but greatly facilitates communication between people. Other examples include virtual environments like Second Life or other such video games, where one may perceive virtual character interaction as gestural—however, such communication is not really gestural.

In consequence, the present inventors have recognized that there is value and need in providing interfaces and/or platforms for online participants of live events or games to interact with each other through gestures, such as applause and cheers, and in gaining a unique experience by acting collectively.

### BRIEF DESCRIPTION OF DRAWINGS

These and other objects, features and characteristics of the present disclosure will become more apparent to those skilled in the art from a study of the following detailed description in conjunction with the appended claims and drawings, all of which form a part of this specification. In the drawings:

FIG. 1 illustrates a prior art social crowd at a physical venue.

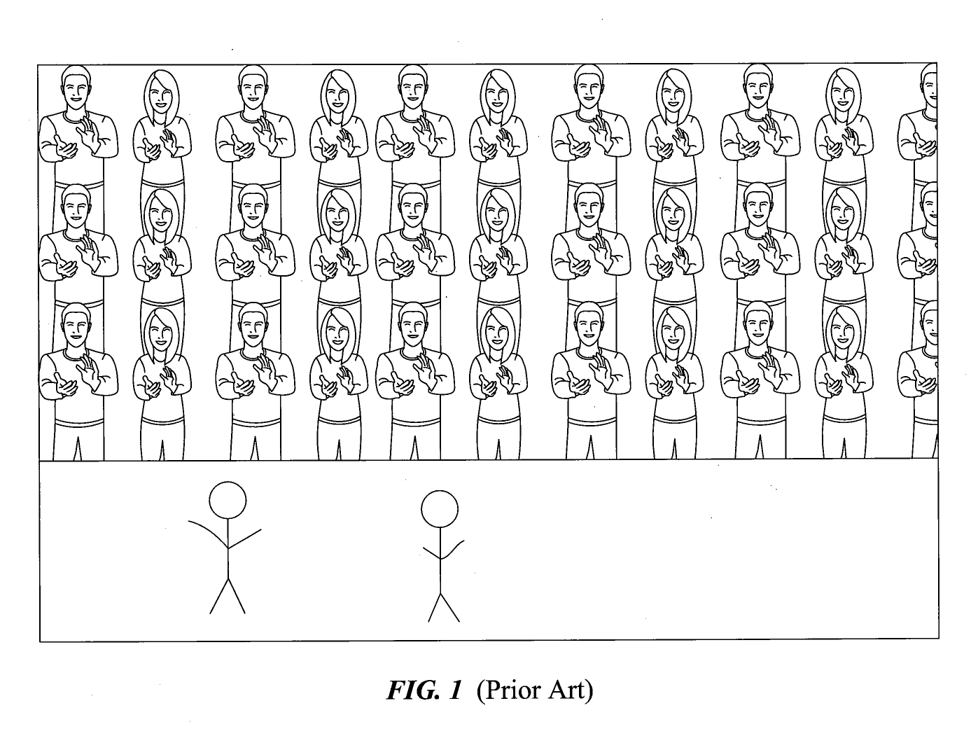

FIG. 2A illustrates a plurality of computers that are connected via Internet (prior art), which allow participants playing games together through the computers.

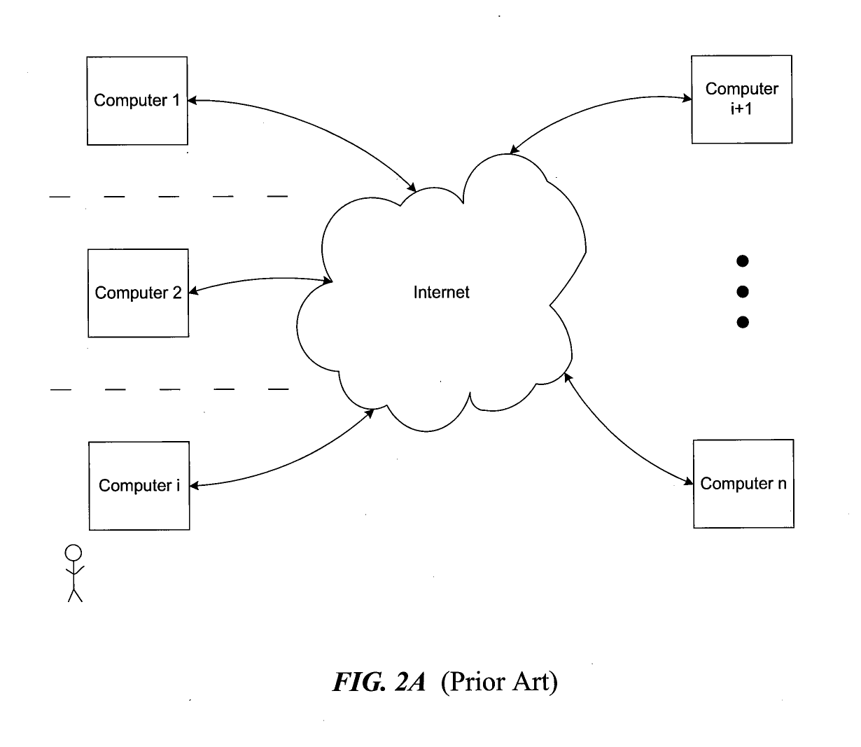

FIG. 2B illustrates prior art human to human gestural communications assisted by technology.

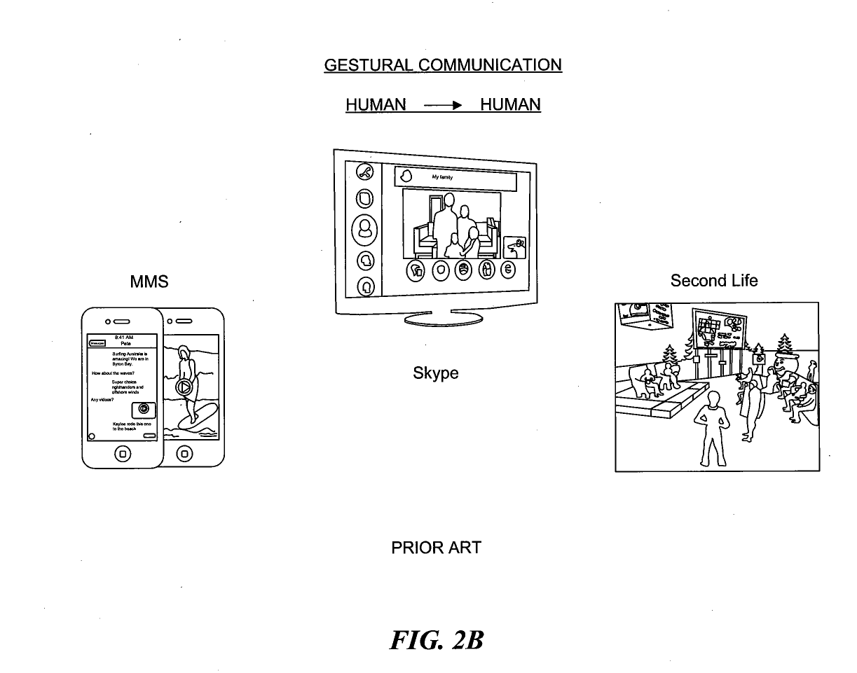

FIG. 3A illustrates a block diagram of a personal experience computing environment, according to one embodiment of the present disclosure.

FIG. 3B illustrates a portable device that has disparate sensors and allows new algorithms for capturing gestures, such as clapping, according to another embodiment of the present disclosure.

FIG. 4 illustrates an exemplary system according to yet another embodiment of the present disclosure.

FIG. 5 illustrates a flow chart showing a set of exemplary operations 500 that may be used in accordance with yet another embodiment of the present disclosure.

FIG. 6 illustrates a flow chart showing a set of exemplary operations 600 that may be used in accordance with yet another embodiment of the present disclosure.

FIG. 7 illustrates a flow chart showing a set of exemplary operations 700 that may be used in accordance with yet another embodiment of the present disclosure.

FIG. 8 illustrates a system architecture for composing and directing participant experiences in accordance with yet another embodiment of the present disclosure.

FIG. 9A illustrates an architecture of a capacity datacenter and a scenario of layer generation, splitting, and remixing in accordance with yet another embodiment of the present disclosure.

FIG. 9B illustrates an exemplary structure of an experience agent in accordance with yet another embodiment of the present disclosure.

FIG. 10 illustrates a telephone conference architecture in accordance with yet another embodiment of the present disclosure.

FIG. 11 illustrates a large scale event with a plurality of physical venues in accordance with yet another embodiment of the present disclosure.

FIG. 12 illustrates an applause service layered on top of a traditional social media platform in accordance with yet another embodiment of the present disclosure.

### DETAILED DESCRIPTION

Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention can include many other obvious features not described in detail herein. Additionally, some well-known structures or functions may not be shown or described in detail below, so as to avoid unnecessarily obscuring the relevant description.

The present disclosure discloses a variety of methods and systems for applause events and gathering experiences. An “applause event” is broadly defined to include events where one or more participants express emotions such as approval or disapproval via any action suitable for detection. Feedback indicative of the applause event is provided to at least one participant. In some embodiments, audio feedback swells and diminishes as a function of factors such as a quantity or number of active participants, and an intensity of the participation. Each participant may have a unique sound associated with his or her various expressions (such as a clapping gesture). The applause event may be enhanced by the system to provide a variety of social aspects.

Participation from a participant in an applause event typically corresponds to the participant performing one or more suitable actions which can be detected by the system. For example, a participant may indicate approval via a clapping gesture made with a portable device held in one hand, the clapping gesture being detected by sensors in the portable device. Alternatively, the participant may literally clap, and a system using a microphone can detect the clapping. A plurality of participants may be participating in the applause event through a variety of gestures and/or actions, some clapping, some cheering, some jeering, and some booing. In some embodiments, the portable device may include two or more disparate sensors. The portable device may further include one or more processors to identify a gesture (e.g. clapping, booing, cheering) made by a participant holding the portable device by analyzing information from the two or more disparate sensors with suitable algorithms. The two or more disparate sensors may include location sensors, an accelerometer, a gyroscope, a motion sensor, a pressure sensor, a thermometer, a barometer, a proximity sensor, an image capture device, and an audio input device etc.

In some embodiments, the system may provide social experience to a plurality of participants. The system may be configured to determine a variety of responses and activities from a specific participant and facilitate an applause event that swells and diminishes in response to the responses and activities from the specific participant. In some embodiments, social and inter-social engagement of a particular activity may be measured by togetherness within a window of the particular activity. In some implementations, windows of a particular activity may vary according to the circumstances. In some implementations, windows of different activities may be different.

In some embodiments, social and inter-social engagements of a specific participant may be monitored and analyzed. Varying participation experiences or audio feedback may be provided to the specific participant depending on the engagement level of the specific participant. In some implementations, as the specific participant increases frequency and/or strength of clapping, the audio feedback may swell, having a nonlinear increase in volume and including multiple and possibly distinct clapping noises. As the specific participant slows down, the audio feedback may diminish in a nonlinear manner. In some implementations, the specific participant may be provided a particular clapping sound depending on the characteristics of the specific participant, e.g. geographic location, physical venue, gender, age etc. In some implementations, the specific participant may be provided clapping sounds with different rhythms or timbres. In some implementations, the specific participant may be provided with a unique clapping sound, a clap signature, or a unique identify that is manifested during the applause process or in past clapping patterns.

Some embodiments may provide methods instantiated on a local computer and/or a portable device. In some implementations, methods may be distributed across local devices and remote devices in the cloud computing service.

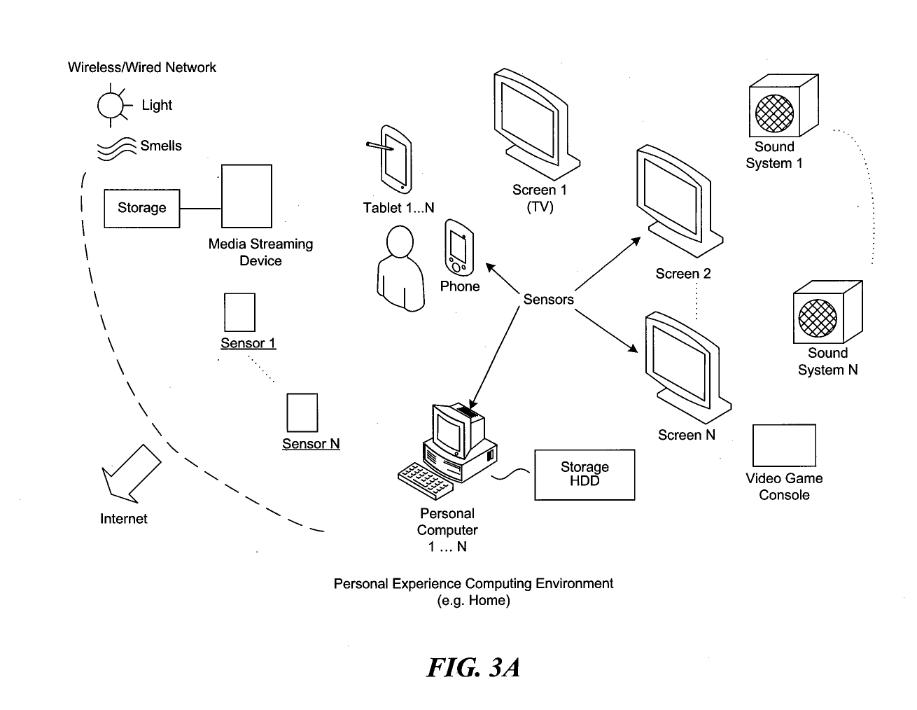

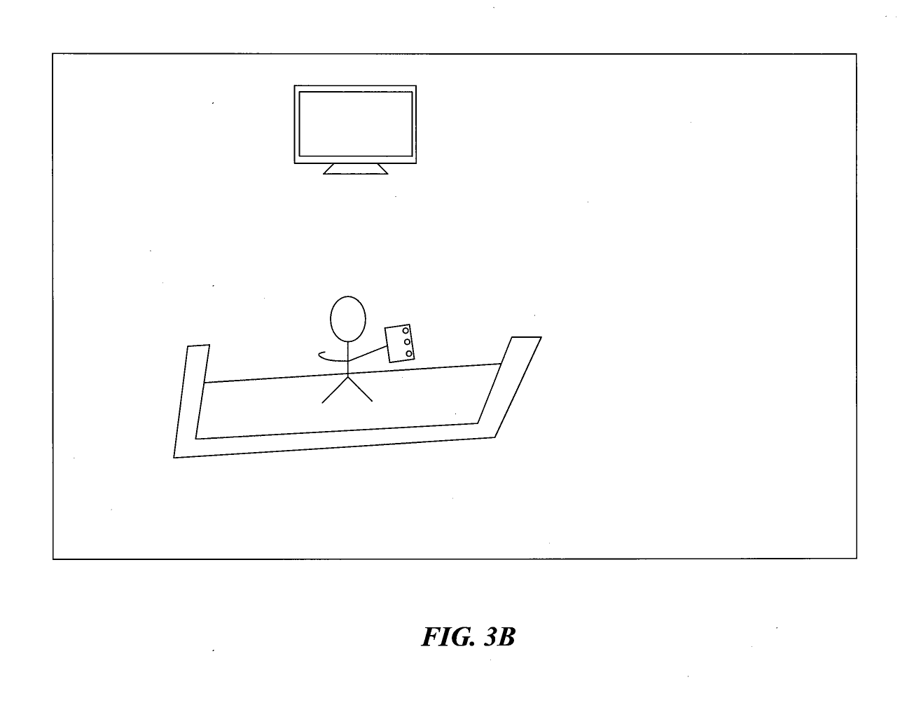

FIG. 3A illustrates a block diagram of a personal experience computing environment, according to one embodiment of the present disclosure. Each personal experience computing environment may include one or more individual devices, multiple sensors, and one or more screens. The one or more devices may include, for example, devices such as a personal computer (PC), a tablet PC, a laptop computer, a set-top box (STB), a netbook, a personal digital assistant (PDA), a cellular telephone, an iPhone®, an Android® phone, an iPad®, and other tablet devices etc. At least some of the devices may be located in proximity to each other and coupled via a wireless network. In some embodiments, a participant may utilize the one or more devices to enjoy a heterogeneous experience, e.g. using the iPhone® to control operation of the other devices. Participants may view a video feed in one device and switch the feed to another device. In some embodiments, multiple participants may share devices at one location, or the devices may be distributed to various participants at different physical venues.

In some embodiments, the screens and the devices may be coupled to the environment through a plurality of sensors, including, an accelerometer, a gyroscope, a motion sensor, a pressure sensor, a temperature sensor, etc. In addition the one or more personal devices may have computing capabilities, including storage and processing power. In some embodiments, the screens and the devices may be connected to the internet via wired or wireless network(s), which allows participants to interact with each other using those public or private environments. Exemplary personal experience computing environments may include sports bars, arenas or stadiums, trade show settings etc.

In some embodiments, a portable device in the personal experience computing environment of FIG. 3A may include two or more disparate sensors, as illustrated in FIG. 3B. The portable device architecture and components in FIG. 3B are merely illustrative. Those skilled in the art will immediately recognize the wide variety of suitable categories of and specific devices such as a cell phone, an iPad®, an iPhone®, a portable digital assistant (PDA), etc. The portable device may include one or more processors and suitable algorithms to analyze data from the two or more disparate sensors to identify or recognize a gesture (e.g., clapping, booing, cheering) made by a human holding the portable device. In some embodiments, the portable device may include a graphics processing unit (GPU). In some embodiments, the two or more disparate sensors may include, for example, location sensors, an accelerometer, a gyroscope, a motion sensor, a pressure sensor, a thermometer, a barometer, a proximity sensor, an image capture device, and an audio input device etc.

In some embodiments, the portable device may work independently to sense participant participation in an applause event, and provide corresponding applause event feedback. Alternatively, the portable device may be a component of a system in which elements work together to facilitate the applause event.

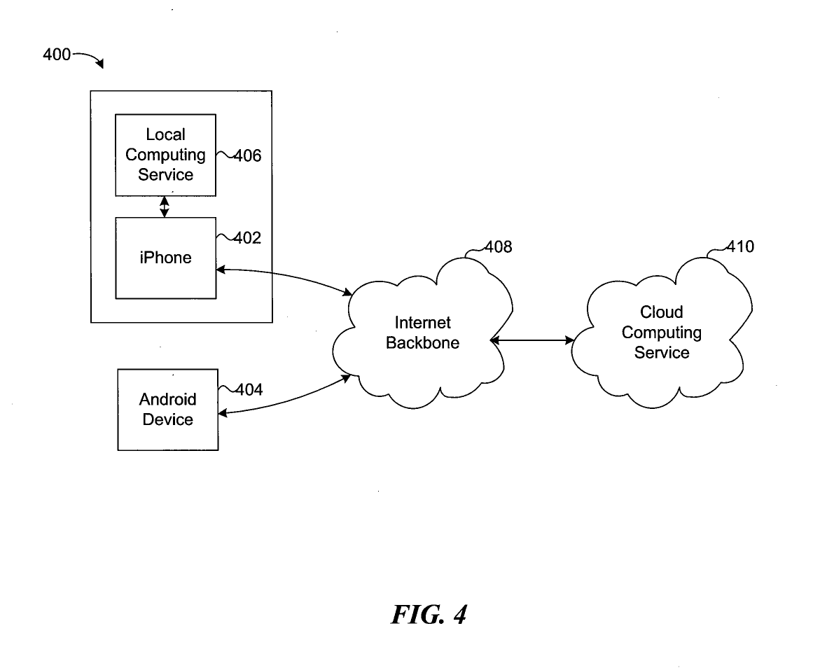

FIG. 4 illustrates an exemplary system 400 suitable for identifying a gesture. The system 400 may include a plurality of portable devices such as iPhone® 402 and Android® device 404, a local computing device 406, and an Internet connection coupling the portable devices to a cloud computing service 410. In some embodiments, gesture recognition functionality and/or operator gesture patterns may be provided at cloud computing service 410 and be available to both portable devices, as the application requires.

In some embodiments, the system 400 may provide a social experience for a variety of participants. As the participants engage in the social experience, the system 400 may ascertain the variety of participant responses and activity. As the situation merits, the system may facilitate an applause event that swells and diminishes in response to the participants actions. Each participant may have unique feedback associated with their actions, such as each participant having a distinct sound corresponding to their clapping gesture. In this way, the applause event has a social aspect indicative of a plurality of participants.

A variety of other social aspects may be integrated into the applause event. For example, participants may virtually arrange themselves with respect to other participants, with the system responding by having those participants virtually closer sounding louder. Participants could even block out the effects of other participants, or apply a filter or other transformation to generate desired results.

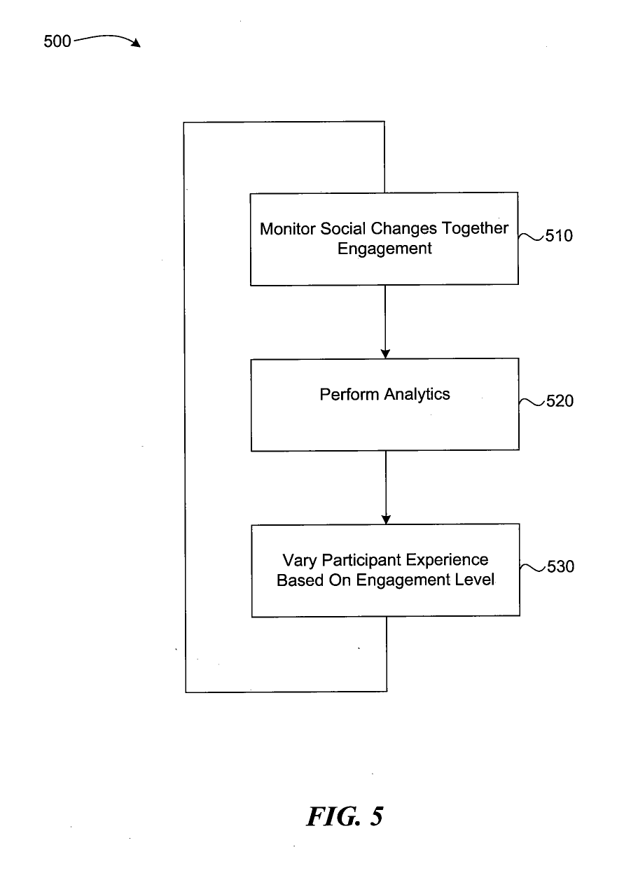

FIG. 5 illustrates a flow chart showing a set of exemplary operations 500 that may be used in accordance with yet another embodiment of the present disclosure. At step 510, the aspects of social and inter-social engagement of each participant may be monitored. In some implementations, social and inter-social engagement of a specific activity may be measured by togetherness within a window of the specific activity. The window is a specific time period related to the specific activity. In some implementations, windows of different activities may be different. In some implementations, a window of a specific activity may vary depending on the circumstances. For example, the window of applause may be 5 seconds in welcoming a speaker to give a lecture. However, the window of applause may be 10 seconds when a standing ovation occurs.

At step 520, the aspects of social and inter-social engagement of each participant may be analyzed. Social and inter-social engagements of participants within the window of a specific activity are monitored, analyzed, and normalized. In some implementations, different types of engagements may be compared. Depending on the engagement level of participants, varying participant experiences or feedback may be provided to each participant, at step 530. For example, in case of applause, a single clap may be converted into crowd-like applause. In some embodiments, a specific participant may have a particular applause sound depending on the geographical location, venue, gender, age, etc of the specific participant. In some implementations, the specific participant may have a unique sound of applause, a clap signature, or a unique identify that is manifested during the applause process. In some implementations, the specific participant's profile, activities, and clap patterns may be monitored, recorded and analyzed.

In some embodiments, the rate and loudness of clapping sounds from a specific participant may be automatically adjusted according to specific activities involved, the specific participant's engagement level and/or past clapping patterns. Audio feedback from a specific participant may swell and diminish in response to the intensity of the specific participant's clapping. In some implementations, the specific participant may manually vary the rate and loudness of clapping sounds perceived by other participants. In some embodiments, clapping sounds with different rhythms and/or timbres may be provided to each participant.

As will be appreciated by one of ordinary skill in the art, the gesture method 500 may be instantiated locally, e.g. on a local computer or a portable device, and may be distributed across a system including a portable device and one or more other computing devices. For example, the method 500 may determine that the available computing power of the portable device is insufficient or that additional computer power is needed, and may offload certain aspects of the method to the cloud.

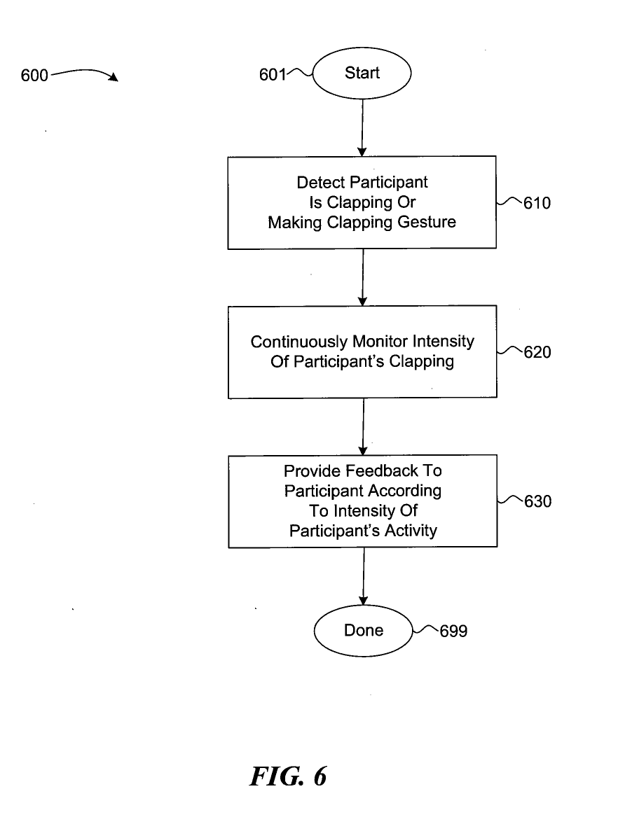

FIG. 6 illustrates a flow chart showing a set of exemplary operations 600 for providing feedback to a specific participant or participant initiating and/or participating in an applause event involving clapping. The method 600 may involve audio feedback swelling and diminishing in response to the intensity of the specific participant's clapping. The method 600 can also provide a social aspect to a specific participant acting alone, by including multiple clapping sounds in the feedback.

The method 600 begins in a start block 601, where any required initialization steps can take place. For example, the specific participant may register or log in to an application that facilitates or includes an applause event. The applause event may be associated with a particular media event such as a group video viewing or experience. However, the method 600 may be stand alone application simply responsive to the specific participant's actions irrespective of other activity occurring. In any event, a step 610 may detect clapping and/or clapping gestures made by the specific participant. As will be appreciated, any suitable means for detecting clapping may be used. For example, a microphone may capture participant-generated clapping sounds, a portable device may be used to capture a clapping gesture, remote sensors may be used to capture the clapping gesture, etc.

A step 620 may continuously monitor the intensity of the participant's clapping. Intensity may include clapping frequency, the strength or volume of the clapping, etc. A step 630 may provide feedback to the participant according to the intensity of the participant's clapping. For example, slow clapping may result in a one-to-one clap to clapping noise feedback at a moderate volume. As the participant increases frequency and/or strength of clapping, the feedback may swell, having a nonlinear increase in volume and including multiple and possibly distinct clapping noises. Fast but soft clapping may produce a plurality of distinct clapping noises, but at a subdued volume. As the participant slows down, the feedback may diminish in a nonlinear manner. In addition or alternative to audio feedback, tactile and/or visual feedback can be provided. For example, a vibration mechanism on a cell phone could be activated, or flashing lights could be activated.

As will be appreciated, the method 600 of FIG. 6 can be extrapolated to a variety of different activities in a variety of different applause events. For example, instead of clapping, the specific participant could be booing, cheering, jeering, hissing, etc. The feedback generated would then correspond to the nature and intensity of the detected activity. Additionally, the feedback could be context-sensitive. In some implementations, the specific participant may put videos in a group activity, resize the videos, or throw virtual objects (e.g. tomatoes, flowers, etc.) at other participants.

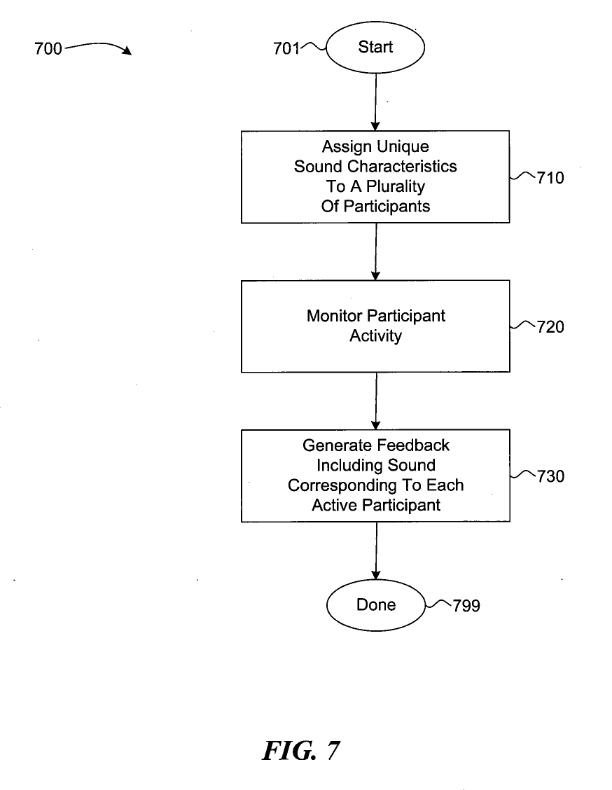

While the method 600 of FIG. 6 is described in the context of a single participant, the present disclosure contemplates a variety of different contexts including multiple participants acting in the applause event. The participants could be acting at a variety of locations, using any suitable devices. With reference to FIG. 7, a method 700 for providing an applause event with a plurality of participants will now be described.

The method 700 of FIG. 7 begins in a start step 701, wherein any initial actions are performed. Step 701 may include various participants logging into an application or social experience which then facilitates participation. A step 710 may assign unique feedback characteristics to each of a plurality of participants in the applause event. For example, each participant may have specific sound characteristics associated with their clap gesture, their “boo,” etc. A step 720 may monitor activity of the plurality of participants, detecting gestures, sounds and other participant activity related to the applause event. A step 730 may generate a feedback signal corresponding to the participant activity detected in step 720. The volume and intensity of the feedback signal may swell and diminish according to the intensity of the participant activity. The feedback signal may also include system-generated aspects. For example, during a period during the experience when applause is expected, the system may provide applause or other suitable feedback, in addition to incorporating a response attributed to participation of the participants.

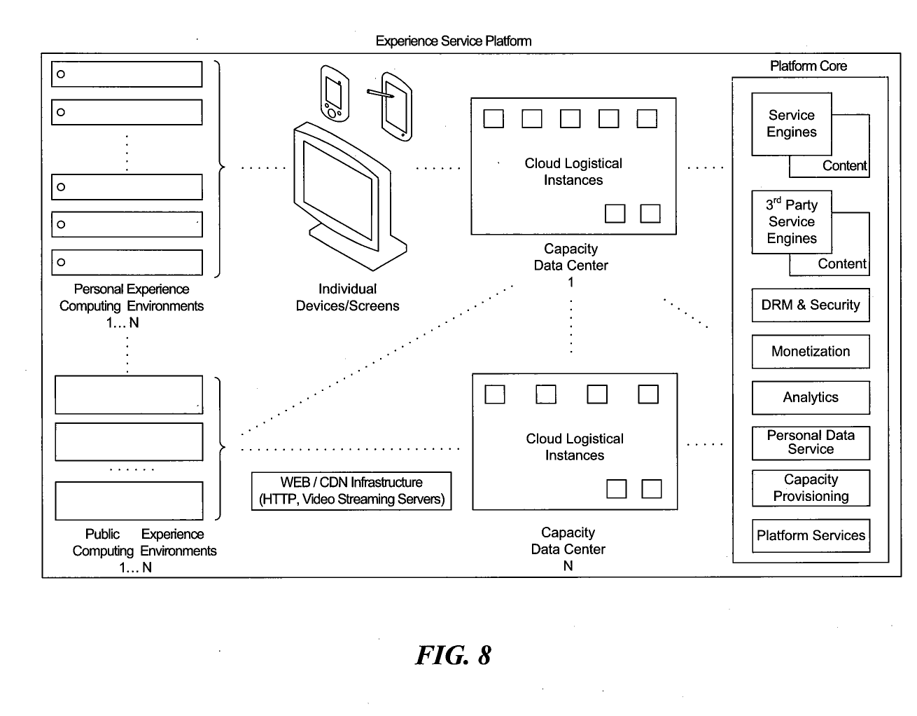

FIG. 8 illustrates a system architecture for composing and directing participant experiences in accordance with yet another embodiment of the present disclosure. In some embodiments, the system architecture may be viewed as an experience service platform. The platform may be provided by a service provider to enable an experience provider to compose and direct a participant experience. In some embodiments, the service provider may monetize the experience by charging the experience provider and/or the participants for services. The participant experience may involve two or more experience participants. The experience provider may create an experience with a variety of dimensions and features. As will be appreciated by one of ordinary skill in the art, FIG. 8 only provides one paradigm for understanding the multi-dimensional experience available to the participants. There are many suitable ways of describing, characterizing and implementing the experience platform contemplated herein.

In some embodiments, the experience service platform may include a plurality of personal experience computing environments, as illustrated in FIG. 3A. Each personal experience computing environment may include one or more individual devices and a capacity data center. Each device or server may have an experience agent. In some embodiments, the experience agent may include a sentio codec and an API. The sentio codec includes a plurality of codecs such as video codecs, audio codecs, graphic language codecs, sensor data codecs, and emotion codecs. The sentio codec and the API may enable the experience agent to communicate with and request services of the components of the data center. In some implementations, the experience agent may facilitate direct interaction between other local devices. Because of the multi-dimensional aspect of the experience, at least in some embodiments, the sentio codec and API may be required to fully enable the desired experience. However, the functionality of the experience agent is typically tailored to the needs and capabilities of the specific device on which the experience agent is instantiated.

In some embodiments, services implementing experience dimensions may be implemented in a distributed manner across the devices and the data center. In some embodiments, the devices may have a very thin experience agent with little functionality beyond a minimum API and sentio codec, and the bulk of the services and thus composition and direction of the experience may be implemented within the data center.

In some embodiments, the experience service platform may further include a platform core that provides the various functionalities and core mechanisms for providing various services. The platform core may include service engines, which in turn are responsible for content (e.g., to provide or host content) transmitted to the various devices. The service engines may be endemic to the platform provider or may include third-party service engines. In some embodiments, the platform core may also include monetization engines for performing various monetization objectives. Monetization of the service platform can be accomplished in a variety of manners. For example, the monetization engine may determine how and when to charge the experience provider for use of the services, as well as tracking for payment to third-parties for use of services from the third-party service engines. Additionally, the service platform may also include capacity-provisioning engines to ensure provisioning of processing capacity for various activities (e.g., layer generation, etc.).

In some embodiments, the experience service platform (or, in some implementations, the platform core) may include one or more of the following: a plurality of service engines, third party service engines, etc. In some embodiments, each service engine has a unique, corresponding experience agent. In other embodiments, a single experience can support multiple service engines. The service engines and the monetization engines can be instantiated on one server, or can be distributed across multiple servers. In some implementations, the service engines may correspond to engines generated by the service provider and provide services such as audio remixing, gesture recognition (e.g. clapping etc), and other services referred to in the context of dimensions above, etc. Third-party service engines are services included in the experience service platform provided by other parties. The experience service platform may have the third-party service engines instantiated directly therein, or within the experience service platform.

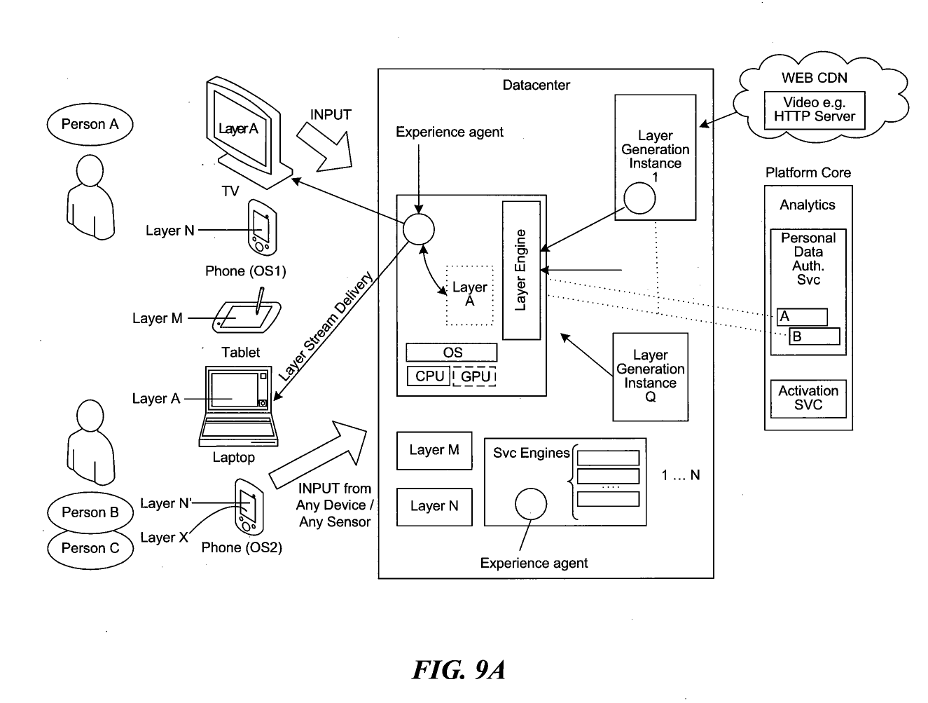

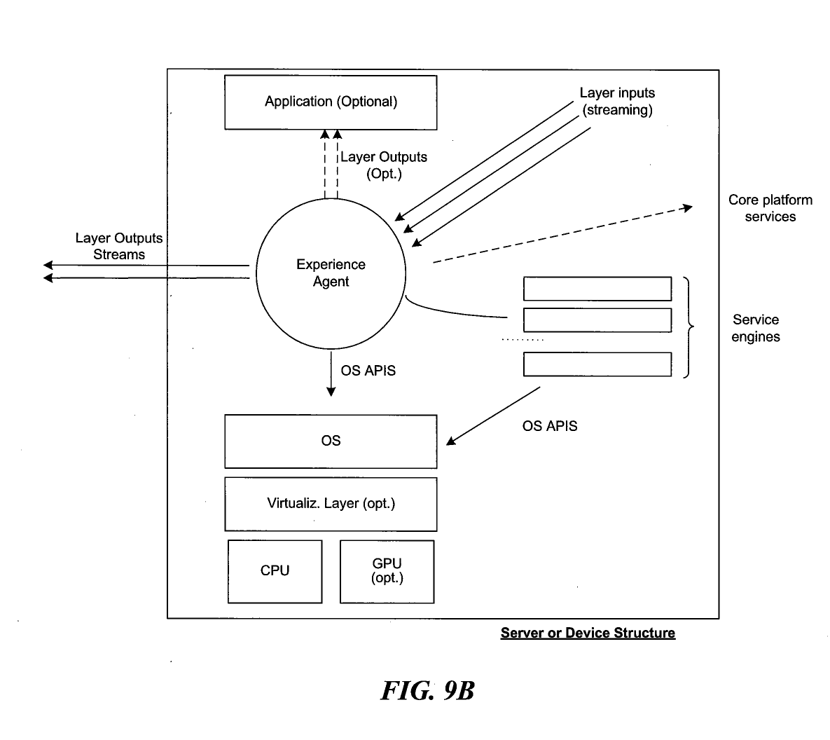

As illustrated in FIG. 9A, the data center may include features and mechanisms for layer generation. In some embodiments, the data center may include an experience agent for communicating and transmitting layers to the various devices. As will be appreciated by one of ordinary skill in the art, a data center may be hosted in a distributed manner in the “cloud,” and the elements of the data center may be coupled via a low latency network. FIG. 9A further illustrates the data center receiving inputs from various devices or sensors (e.g., by means of a gesture (e.g., clapping etc) for a virtual experience to be delivered), and the data center causing various corresponding layers to be generated and transmitted in response. The data center may include a layer or experience composition engine.

In some embodiments, the composition engine may be defined and controlled by the experience provider to compose and direct the experience for one or more participants utilizing devices. Direction and composition is accomplished, in part, by merging various content layers and other elements into dimensions generated from a variety of sources such as the service provider, the devices, content servers, and/or the experience service platform. In some embodiments, the data center may include an experience agent for communicating with, for example, the various devices, the platform core, etc. The data center may also comprise service engines and/or connections to one or more virtual engines for the purpose of generating and transmitting the various layer components. The experience service platform, platform core, data center, etc. can be implemented on a single computer system, or more likely distributed across a variety of computer systems, and at various locations.

In some embodiments, the experience service platform, the data center, the various devices, etc. may include at least one experience agent and an operating system, as illustrated in FIG. 9B. The experience agent may optionally communicate with the application for providing layer outputs. For example, the experience agent may be responsible for receiving layer inputs transmitted by other devices or agents, or transmitting layer outputs to other devices or agents. In some implementations, the experience agent may also communicate with service engines to manage layer generation and streamlined optimization of layer output.

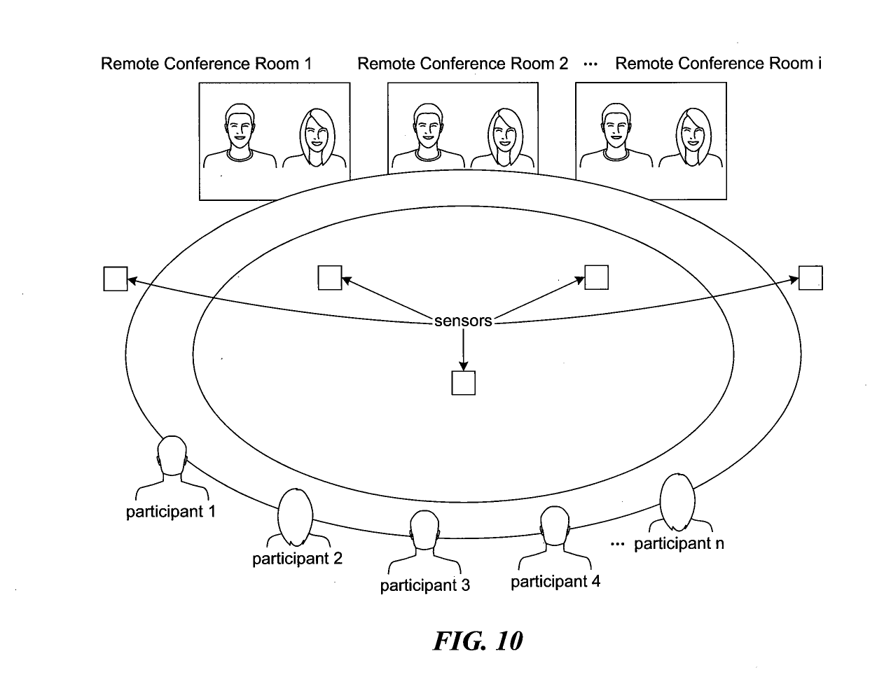

FIG. 10 illustrates a telephone conference architecture in accordance with yet another embodiment of the present disclosure. Personal gathering experience may be provided for participants at various physical venues attending a telephone conference meeting. Each gathering experience environment at a specific physical venue may include a plurality of devices, two or more disparate sensors, and one or more screens. In some implementations, two or more disparate sensors may be installed at each specific physical venue. In some implementations, two or more disparate sensors may be included in a portable device held by a specific participant at the specific physical venue. One or more devices at each gathering experience environment may be configured to identify and/or recognize a gesture (e.g., clapping, booing, cheering, etc) from each specific participant and provide varying participant experiences or feedback to the specific participant according to the engagement level of the specific participant. As will be appreciated by one of ordinary skill in the art, the telephone conference architecture may be applied to various online games and/or events, for example massively multiplayer online role-playing game (MMORPG) etc.

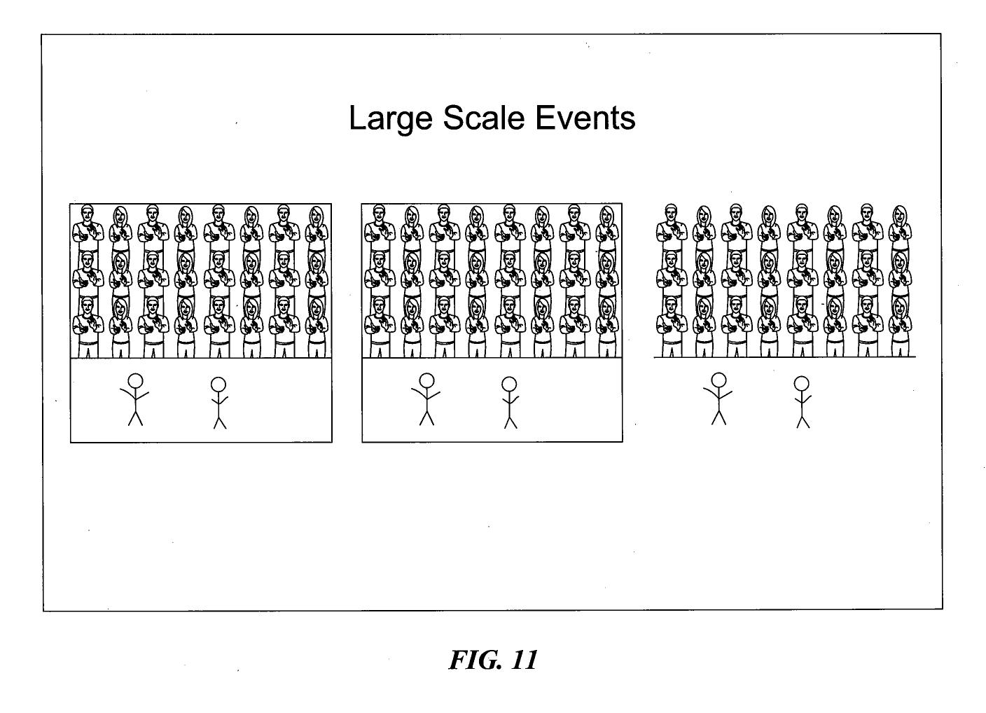

FIG. 11 illustrates a large scale event with a plurality of physical venues in accordance with yet another embodiment of the present disclosure. An event may be live at a physical venue and is broadcasted simultaneously to a plurality of remote physical venues. Personal gathering experience may be provided for participants at a specific remote physical venue as a group. Each gathering experience environment may include a plurality of devices, two or more disparate sensors, and one or more screens. The two or more disparate sensors may be configured to identify and/or recognize the group clapping and/or other group gestures at the specific remote physical venue. Varying participant experiences or feedback may be provided to participants at the remote specific physical venue according to the engagement level of the participants at the specific remote physical venue.

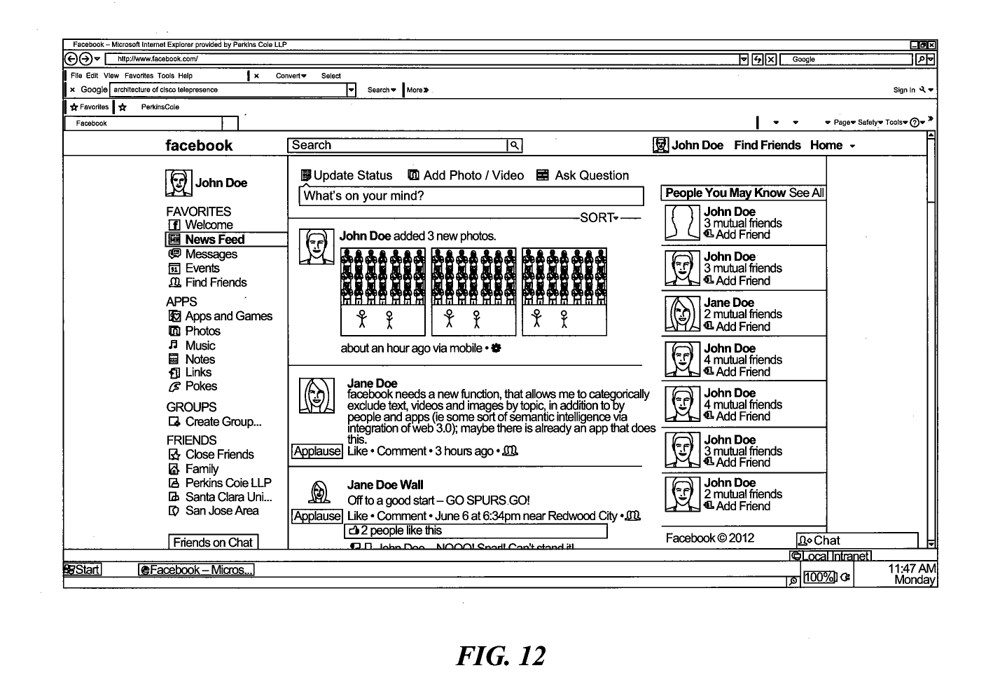

FIG. 12 illustrates an applause service layered on top of a traditional social media platform in accordance with yet another embodiment of the present disclosure. In some embodiments, connected participants of a traditional social media platform (e.g., Facebook® etc.) may choose to activate the applause service and engage in a specific activity collectively. Various audio feedback or experiences may be provided to a specific participant according to the engagement level of the specific participant.

Unless the context clearly requires otherwise, throughout the description and the claims, the words “comprise,” “comprising,” and the like are to be construed in an inclusive sense (i.e., to say, in the sense of “including, but not limited to”), as opposed to an exclusive or exhaustive sense. As used herein, the terms “connected,” “coupled,” or any variant thereof means any connection or coupling, either direct or indirect, between two or more elements. Such a coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. While processes or blocks are presented in a given order in this application, alternative implementations may perform routines having steps performed in a different order, or employ systems having blocks in a different order. Some processes or blocks may be deleted, moved, added, subdivided, combined, and/or modified to provide alternative or sub-combinations. Also, while processes or blocks are at times shown as being performed in series, these processes or blocks may instead be performed or implemented in parallel, or may be performed at different times. Further any specific numbers noted herein are only examples. It is understood that alternative implementations may employ differing values or ranges.

The various illustrations and teachings provided herein can also be applied to systems other than the system described above. The elements and acts of the various examples described above can be combined to provide further implementations of the invention.

Any patents and applications and other references noted above, including any that may be listed in accompanying filing papers, are incorporated herein by reference. Aspects of the invention can be modified, if necessary, to employ the systems, functions, and concepts included in such references to provide further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

While certain aspects of the invention are presented below in certain claim forms, the applicant contemplates the various aspects of the invention in any number of claim forms. For example, while only one aspect of the invention is recited as a means-plus-function claim under 35 U.S.C. §112, sixth paragraph, other aspects may likewise be embodied as a means-plus-function claim, or in other forms, such as being embodied in a computer-readable medium. (Any claims intended to be treated under 35 U.S.C. §112, ¶6 will begin with the words “means for.”) Accordingly, the applicant reserves the right to add additional claims after filing the application to pursue such additional claim forms for other aspects of the invention

In addition to the above mentioned examples, various other modifications and alterations of the invention may be made without departing from the invention. Accordingly, the above disclosure is not to be considered as limiting and the appended claims are to be interpreted as encompassing the true spirit and the entire scope of the invention.

What is claimed is:

1. A computer-implemented method for providing gathering experience to a plurality of online participants of a live event, the method comprising:
within a window of a specific activity, monitoring the aspects of social and inter-social engagement of each participant; wherein the window of the specific activity is a specific time period related to the specific activity; wherein the aspects of social and inter-social engagement includes gestures, videos and audios from each participants;
within the window of the specific activity, analyzing the social and inter-social engagement of each participant;
and
providing varying participant experiences to a specific participant depending on the engagement level of the specific participant.

2. The computer-implemented method as recited in claim 1, wherein the gathering experience includes an applause event.

3. The computer-implemented method as recited in claim 2, the method further comprising:
detecting gestures made by the specific participant through two or more disparate sensors, wherein the gestures include clapping;
monitoring the intensity of the clapping from the specific participant;
and
providing feedback to the specific participant according to the intensity of the clapping, wherein the intensity of the clapping is determined by the frequency and/or strength of the clapping.

4. The computer-implemented method as recited in claim 3, wherein the feedback includes audio, tactile, and/or visual feedback.

5. The computer-implemented method as recited in claim 4, wherein the audio feedback include clapping feedback, the clapping feedback having different clapping rates, loudness, rhythms, and/or timbres depending on the specific participant's engagement level and/or past clapping patterns.

6. The computer-implemented method as recited in claim 4, wherein the audio feedback swells and diminishes as a function of factors, the factors including a number of active participants and an intensity of participation;
when the specific participant increases frequency and/or strength of clapping, the audio feedback swells, having a nonlinear increase in volume and including distinct clapping noises; and
when the specific participant decreases frequency and/or strength of clapping, the audio feedback diminishes nonlinearly.

7. The computer-implemented method as recited in claim 6, the method further comprising:
assigning unique feedback characteristics to the specific participant in the applause event.

8. The computer-implemented method as recited in claim 7, wherein the unique feedback characteristics depend on the geographic location, venue, gender, age, and/or online activity patterns of the specific participant.

9. The computer-implemented method as recited in claim 8, the method further comprising: providing options for the specific participant to manually modify assigned unique feedback characteristics.

10. The computer-implemented method as recited in claim 1, wherein the method is instantiated on one or more local devices or distributed across a system including one or more local devices and remote computing devices.

11. A system for providing gathering experience to a plurality of online participants of a live event, the system comprising:
an experience service platform; and
an application program instantiated on the experience service platform, wherein the application provides computer-generated output;
wherein the experience service platform is configured to:
within a window of a specific activity, monitor the aspects of social and inter-social engagement of each participant; wherein the window of the specific activity is a specific time period related to the specific activity; wherein the aspects of social and inter-social engagement includes gestures, videos and audios from each participants;
within the window of the specific activity, analyze the social and inter-social engagement of each participant;
and
provide varying participant experiences to a specific participant depending on the engagement level of the specific participant.

12. The system as recited in claim 11, wherein the gathering experience includes an applause event.

13. The system as recited in claim 12, wherein the experience service platform is further configured to:
detect gestures made by the specific participant through two or more disparate sensors, wherein the gestures include clapping;
monitor the intensity of the clapping from the specific participant;
and
provide feedback to the specific participant according to the intensity of the clapping, wherein the intensity of the clapping is determined by the frequency and/or strength of the clapping.

14. The system as recited in claim 13, wherein the feedback includes audio, tactile, and/or visual feedback.

15. The system as recited in claim 14, wherein the audio feedback include clapping feedback, the clapping feedback having different clapping rates, loudness, rhythms, and/or timbres depending on the specific participant's engagement level and/or past clapping patterns.

16. The system as recited in claim 14, wherein the audio feedback swells and diminishes as a function of factors, the factors including a number of active participants and an intensity of participation.

17. The system as recited in claim 16, wherein, when the specific participant increases frequency and/or strength of clapping, the audio feedback swells, having a nonlinear increase in volume and including distinct clapping noises; and, when the specific participant decreases frequency and/or strength of clapping, the audio feedback diminishes nonlinearly.

18. The system as recited in claim 17, wherein the experience service platform is further configured to assign unique feedback characteristics to the specific participant in the applause event.

19. The system as recited in claim 18, wherein the unique feedback characteristics depend on the geographic location, venue, gender, age, and/or online activity patterns of the specific participant.

20. The system as recited in claim 19, wherein the experience service platform is further configured to provide options for the specific participant to manually modify assigned unique feedback characteristics.

21. The system as recited in claim 20, wherein the intensity of the applause event is a function of a number of participants participating.

22. An apparatus for providing gathering experience to a plurality of online participants of a live event, the apparatus comprising:
means for, within a window of a specific activity, monitoring the aspects of social and inter-social engagement of each participant; wherein the window of the specific activity is a specific time period related to the specific activity; wherein the aspects of social and inter-social engagement includes gestures, videos and audios from each participants;
means for, within the window of the specific activity, analyzing the social and inter-social engagement of each participant;
and
means for providing varying participant experiences to a specific participant depending on the engagement level of the specific participant.

23. The apparatus as recited in claim 22, wherein the gathering experience includes an applause event.

24. The apparatus as recited in claim 23, further comprising:
means for detecting gestures made by the specific participant through two or more disparate sensors, wherein the gestures include clapping;
means for monitoring the intensity of the clapping from the specific participant;
and
means for providing feedback to the specific participant according to the intensity of the clapping, wherein the intensity of the clapping is determined by the frequency and/or strength of the clapping.

25. The apparatus as recited in claim 24, wherein the feedback includes audio, tactile, and/or visual feedback.

26. The apparatus as recited in claim 25, wherein the audio feedback include clapping feedback, the clapping feedback having different clapping rates, loudness, rhythms, and/or timbres depending on the specific participant's engagement level and/or past clapping patterns.

27. The apparatus as recited in claim 25, wherein the audio feedback swells and diminishes as a function of factors, the factors including a number of active participants and an intensity of participation.

28. The apparatus as recited in claim 27, wherein, when the specific participant increases frequency and/or strength of clapping, the audio feedback swells, having a nonlinear increase in volume and including distinct clapping noises; and, when the specific participant decreases frequency and/or strength of clapping, the audio feedback diminishes nonlinearly.

29. The apparatus as recited in claim 28, further comprising means for assigning unique feedback characteristics to the specific participant in the applause event.

30. The apparatus as recited in claim 29, wherein the unique feedback characteristics depend on the geographic location, venue, gender, age, and/or online activity patterns of the specific participant.

31. The apparatus as recited in claim 30, further comprising means for providing options for the specific participant to manually modify assigned unique feedback characteristics.

32. The apparatus as recited in claim 31, wherein the intensity of the applause event is a function of a number of participants participating.
